(19) United States
(12) Patent Application Publication
(10) Pub. No.: US 2005/0243268 A1
(43) Pub. Date: Nov. 3, 2005

(54) Pair of substrates spaced from each other by spacers having a pre-determined pattern and method of making thereof

(75) Inventors: Giovanni Nisato, Eindhoven (NL); Michel Marcel Jose Decre, Eindhoven (NL); Bert-Hendrik Huisman, Eindhoven (NL); Petru Cornelis Paulus Bouten, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/528,296

(22) PCT Filed: Aug. 8, 2003
(86) PCT No.: PCT/IB03/03555

§ 371 Date: Mar. 16, 2005

(30) Foreign Application Priority Data
Sep. 19, 2002 (NL) 1021489

(51) Int. Cl. G02F 1/13

(52) U.S. Cl. 349/201

(57) ABSTRACT

The invention pertains to a method of obtaining a pair of substrates spaced from each other by spacers comprising: a) providing a first substrate overlaid with a first layer with a patterned hydrophobic second layer or a patterned hydrophilic second layer that can take on an electrostatic charge; and b) optionally treating the parts of the first layer that are not covered with the hydrophobic or hydrophilic second layer to form a patterned hydrophilic third layer that can take on an electrostatic charge with a sign that is opposite to the sign of the electrostatic charge that can be taken on by the hydrophilic second layer, if the second layer is a hydrophilic layer; c) providing at least one of the first, second, and third layer with an electrostatic charge; d) contacting the electrostatically charged patterned first substrate with a dispersion of polymeric particles (spacers), which are functionalized so that the polymeric particles at their surface can take on an electrostatic charge with a sign opposite to the sign of the electrostatic charge of the at least one of the first, second, and third layer, to electrostatically bond the polymeric particles to the layer provided with an electrostatic charge having a sign that is opposite to the sign of the electrostatic charge of the polymeric particles; e) optionally removing the functionalized polymeric particles from parts to which the functionalized polymeric particles are not electrostatically bonded, and/or the hydrophobic or hydrophilic second layer, if the polymeric particles are not electrostatically bonded thereto; and f) thereafter connecting the first substrate to a second substrate to give the pair of substrates.

The invention pertains to a method of obtaining a pair of substrates spaced from each other by spacers, to said pair of substrates spaced from each other by spacers, and to a device and an LCD display comprising the pair of substrates spaced from each other by spacers.

In a liquid crystal cell of a device such as a liquid crystal electro-optical device, the spacing between the substrates in the cell is generally maintained constant by sparsely distributing silicon oxide spheres about several micrometers in diameter as spacers between the substrates. The spacers are thus held between the substrates to maintain the distance between the substrates at a constant value. The distance is determined by the diameter of the spacers. The spacers assure the minimum spacing between the substrates; i.e., they prevent a decrease in distance between the substrates from occurring. Spacers placed according to a regular geometrical pattern are more effective to control the cell gap homogeneously, particularly for plastic substrates.

When such spacers are used for maintaining the spacing between the substrates constant, a liquid crystal display having a large image display area using a liquid crystal, particularly ferro-electric liquid crystal, is unfeasible because the display experiences disturbances. This problem occurs in the liquid crystal displays using not only ferro-electric liquid crystals but also any kind of liquid crystal materials. To avoid this problem, in addition to the spacers, adhesive materials (scattered in a liquid crystal cell) based on an organic resin for fixing the spacing between the substrates are used. These types of organic resin adhesives are provided as spheres larger than the spacing between the substrates so that they may deform and tightly adhere one substrate to the other upon applying pressure thereto.

In U.S. Pat. No. 5,739,882 a fabrication process has been disclosed for making such liquid crystal electro-optical devices. According to this fabrication process resin columns are prepared by bringing uncured resin onto desired positions of the substrate and curing the resin material so that polymerized spacers are formed. This process, however, has some drawbacks. Firstly, before the column-like spacers are formed at the desired positions, the pair of substrates must be kept at the desired predetermined distance by using “temporary” spacers that are scattered randomly between the pair of substrates and which cannot be removed after the permanently cured resin spacers have been formed. Then the two substrates are fixed by adhering them together using a two-liquid epoxy resin adhesive as the sealing material. The two-liquid epoxy resin adhesive is applied to the periphery of one of the substrates by screen-printing, and the two substrates are adhered to fix. The plate for screen-printing is oriented with the substrate in such a manner that each of the warps and the wefts may be superposed to the positions corresponding to the scanning electrodes and the signal electrodes, respectively. Secondly, the prior art method at least needs extra production steps, i.e. scattering the temporary spacers between the substrates, performing a curing step of the resin to obtain column-like spacers. Such complicated method of manufacture makes the device more expensive. Furthermore, this method leads to unpolymerized contaminants, which compromise the electro-optic performance of the device.

It is therefore an object of the present invention to obtain a method of distancing the pair of substrate in a simple manner, without the need to make use of temporary spacers and simplifying the method of production considerably.

To this end a method was found wherein a pair of substrates is obtained by a procedure wherein a pair of substrates is spaced from each other by spacers comprising:
a) providing a first substrate overlaid with a first layer with a patterned hydrophobic second layer or a patterned hydrophilic second layer that can take on an electrostatic charge; and
b) optionally treating the parts of the first layer that are not covered with the hydrophobic or hydrophilic second layer to form a patterned hydrophilic third layer that can take on an electrostatic charge with a sign that is opposite to the sign of the electrostatic charge that can be taken on by the hydrophilic second layer, if the second layer is a hydrophilic layer;
c) providing at least one of the first, second, and third layer with an electrostatic charge;
d) contacting the electrostatically charged patterned first substrate with a dispersion of polymeric particles (spacers), which are functionalized so that the polymeric particles at their surface can take on an electrostatic charge with a sign opposite to the sign of the electrostatic charge of the at least one of the first, second, and third layer, to electrostatically bond the polymeric particles to the layer provided with an electrostatic charge having a sign that is opposite to the sign of the electrostatic charge of the polymeric particles;
e) optionally removing the functionalized polymeric particles from parts to which the functionalized polymeric particles are not electrostatically bonded, and/or the hydrophobic or hydrophilic second layer, if the polymeric particles are not electrostatically bonded thereto; and
f) thereafter connecting the first substrate to a second substrate to give the pair of substrates.

In step a) the first layer can be patterned, leaving insulating areas exposed. The first layer can be of any material, but usually it is an alignment layer, such as a polyimide, or a conductive or semi-conductive layer, such as an ITO layer, which can chemically be patterned. It is also possible that the first layer is a conductive or semi-conductive layer overlaid with an alignment layer. The first layer can be part of a flexible polymer-based substrate or an inflexible substrate such as a glass substrate. The first layer can also be an integral part of the substrate, for instance the top layer of a metallic substrate. The second layer is made of a hydrophobic or hydrophilic compound and may, for instance, be a patterned self-assembled monolayer (SAM) of protected hydrophobic molecules, such as octadecyltrichlorosilane (OTS) and the like, which can be applied in a conventional manner as known by the artisan, such as by micro-contact printing with a silicon rubber stamp. Hydrophylic layers can be made of 3-(2-aminoethylamino)propyltrimethoxysilane, 3-aminopropyl-3-methoxysilane, and the like, as is known to the skilled person. When the first layer is a conductive or semi-conductive layer, this layer can take on an electrostatic charge by chemical treatment, for instance by treating an ITO layer with hydrogen chloride, or by applying an electric voltage. Hydrophilic second and third layers can be charged by applying a suitable pH, after which acidic or basic groups are converted to anionic and cationic groups, respectively.

The polymeric spacers are end-functionalized with a group that can be electrostatically charged, such as an acid group like carboxylic acid, sulfonic acid, phosphonic acid, and the like, which at a suitable pH are converted to negatively charged carboxylate, sulfonate, and phosphonate groups, respectively. The end group may also be a basic group such as an amine, preferably primary and tertiary amine, which groups can take on a positive electrostatic charge at the suitable pH. The spacers may have any form, among which column-like, ellipsoidal, cylindrical, and spherical. Spherical and spherical-like particles are preferred, more preferably having diameter of about 1 μm to about 10 μm, since they are easily available and can advantageously be attached to pre-determined sites. Substrates making use of these end-functionalized particles are novel and are also an embodiment of the present invention. In a suitable method, after patterning, the substrates are dipped in a water suspension or dispersion of such particles. In a suitable embodiment the polymeric spacers selectively absorb to the non-protected (non-covered) parts of the first layer surface and excess of spacer can easily be rinsed off. The pH of the solution may be adjusted to optimize the process in one or more of its characteristics, among which rate and interaction strength. An alternative of this process is to deposit an intermediate SAM or a linear or dendritic polyelectrolyte layer onto the uncovered areas before contacting it with the spacer. It is stressed that this alternative includes the combination of different soft-lithographic and deposition steps. After these processes orienting means for orienting (aligning) the liquid crystal molecules along one direction may be provided on the inner side of at least one of the pair of substrates, so that the liquid crystals are oriented optionally after rubbing the layer before alignment.

It is preferred to position clusters of spacers such that they do not interfere with the optical performance of the device, i.e. preferably not on the surface of a pixel, but only at the edges or corners thereof.

In a related aspect, the invention relates to a pair of substrates spaced from each other by polymeric particles (spacers) wherein the polymeric particles are positioned between the pair of substrates in a pre-determined pattern and are functionalized so that the polymeric particles at their surface have groups that can take on an electrostatic charge. In particular, the particles can take on a charge with a sign that is opposite to the sign of the electrostatic charge that can be taken on by at least one of the first, second, or third layer to which it is in contact.

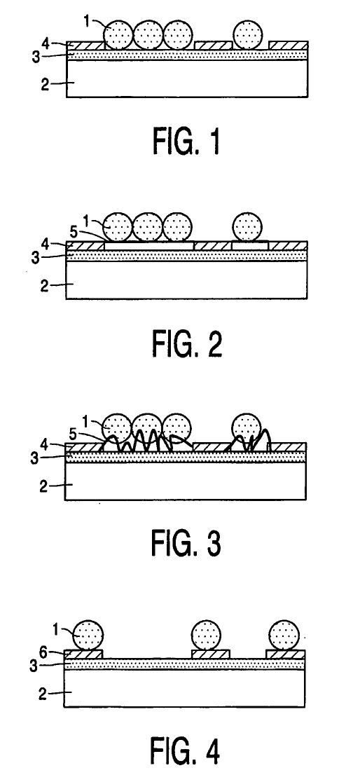

The principle of the present method is illustrated in FIGS. 1-4.

FIG. 1 shows a substrate with a charged first layer, which is patterned by a hydrophobic second layer, and functionalized spacers.

FIG. 2 shows an alternative of FIG. 1 with a hydrophilic second and a third layer.

FIG. 3 shows an alternative of FIG. 2 wherein the hydrophilic third layer is a polyelectrolyte or a dendrimer.

FIG. 4 shows a substrate, with a first layer and a hydrophilic second or third layer and spacers bonded thereto.

Referring to FIG. 1, a part of a liquid crystal electro-optical device is shown utilizing spherical functionalized spacers 1, comprising a light-transmitting substrate 2. Not shown in FIGS. 1-4 are the second substrate that is placed onto the first substrate and spaced to a specified distance from the first substrate by the spacers, and optional electrodes, orientation films, liquid crystal material, and sealing material. The spacers have, for instance, an electrostatic negative charge and are bonded to the first layer 3, which in this particular case is an ITO layer that is chemically modified by hydrogen chloride to give a positive electrostatic charge. The spacers have no interaction with the hydrophobic second layer 4 (for instance an OTS layer) that is patterned onto the first layer 3 and these areas are therefore free form polymeric particles 1.

In FIG. 2 the situation is depicted wherein the second layer 4 is not a hydrophobic layer (such as OTS), but a negatively charged hydrophilic layer. The areas of first layer 3 that are not covered by the hydrophilic second layer 4 are then provided with a hydrophilic third layer 5 having a positive electrostatic charge, which is opposite to the charge of the hydrophilic second layer. The negatively charges spacers adhere to the positively charged third layer 5, and not to the negatively charged second layer 4. After bonding of the spacers 1, the second layer 4 may optionally be removed, after which a configuration is obtained that is depicted in FIG. 4, wherein number 6 then refers to hydrophilic third layer 5.

In FIG. 3 a special embodiment of FIG. 2 is shown, wherein the third layer 5 is a high-molecular polyelectrolyte or a dendrimer to which the spacers bond.

FIG. 4 shows the situation wherein the hydrophobic or hydrophilic second layer 4 has been removed (from the embodiments as presented in FIGS. 2 and 3) and wherein number 6 refers to third layer 5 (which also may be of the high-molecular polyelectrolyte or dendrimer type), which is electrostatically bonded to the functionalized polymeric particles.

FIG. 4 also represents an embodiment wherein the second layer 4, having groups that are electrostatically charged with the sign opposite to the sign of the electrostatically charged polymeric particles 1, is patterned onto the first layer, which is not charged or is electrostatically charged with the same sign as that of the electrostatically charged polymeric particles 1, after which the functionalized polymeric particles I are bonded to second layer 4. For instance, this embodiment is obtained when layer 3 is an alignment layer that is directly provided onto the substrate. In this embodiment second layer 4 (indicated by number 6 in FIG. 4) may also be of the high-molecular polyelectrolyte or dendrimer type.

The above methods provide devices that are also an object of the invention. Thus the invention also pertains to a device comprising two substrates spaced from each other by polymeric particles (spacers) 1, at least the first substrate 2 being overlaid with a first layer 3 and patterned by a hydrophobic or hydrophilic second layer 4, and optionally by a hydrophilic third layer 5 that has an electrostatic charge with a sign that is opposite to the sign of the electrostatic charge of the hydrophilic second layer, if the second layer is a hydrophilic layer; and wherein at least one of the first, second, and third layer has an electrostatic charge, characterized in that the polymeric particles are positioned between the pair of substrates in a pre-determined pattern and are functionalized so that the polymeric particles at their surface have an electrostatic charge with a sign that is opposite to the sign of the electrostatic charge of at least one of the first, second, or third layer to which the polymeric particles are electrostatically bonded.

Preferably, the spacers have a spherical or spherical-like shape as previously explained.

The invention is also particularly useful for application in LCD displays. LCD displays are well known in the art, see for example “Liquid Crystal Devices: Physics and Applications (Artech House Optoelectronics Library) Vladimir G. Chigrinov, pp. 215-2, Artech House; ISBN: 0890068984; (April 1999).

Such LCD displays may comprise a pair of substrates according to the invention, preferably a pair of substrates spaced from each other by polymeric particles (spacers), wherein the polymeric particles are positioned between the pair of substrates in a pre-determined pattern and are functionalized so that the polymeric particles at their surface have groups that can take on an electrostatic charge with a sign that is opposite to the sign of the electrostatic charge that can be taken on by at least one of the first, second, or third layer to which it is in contact.

The polymeric particles may be electrostatically bonded through their functional groups to a charged layer it is also possible that the functionalized particles, dispersed in a medium wherein the functional groups can be ionized, are electrostatically bonded to a layer that is charged by applying a voltage. For instance, a metal layer can be charged positively by applying a voltage, after which a dispersion of carboxylate-functional polymeric particles can electrostatically bond to said layer. After having the particles patterned in this manner, the voltage can be removed after which the layer is not longer charged and the charged carboxylate groups of the functionalized particles resume their uncharged carboxylic acid form. In such devices the particles are positioned in a pre-determined pattern, but may not longer be electrostatically bonded in the end product.

The liquid crystal material used in the present embodiment may be any suitable liquid crystal material such as those disclosed in: Low Molecular Weight Liquid Crystals I, Volume 2A, Handbook of Liquid Crystals by George W. Gray (Editor), John W. Goodby (Editor), Hans W. Speiss (Editor), Edited by: Dietrich Demus, John Wiley & Sons; ISBN: 3527292713; 1st edition (Mar. 10, 1998). Specific non-limitative examples are E7™ (ex Merck) and CS1014, a ferroelectric liquid crystal manufactured by Chisso Corporation.

Indium tin oxide (ITO) is the electrode material by choice for use as a first layer and is deposited on a glass substrate (10.times.10 cm in area) by sputtering or vapor deposition to a thickness of from 50 to 200 nm, specifically, 100 nm, and patterned by a conventional photolithography to obtain an electrode. Polyimide may be applied to the surface of the resulting substrate by spin coating, and fired at 280° C. Polyimide suitable for use as the orientation film include RN-305 (a product of Nissan Chemical Industries, Ltd.) and LP-64 (a product of Toray Industries, Inc.). LP-64 is used specifically in the embodiment to form a polyimide film (15 nm in thickness). In general, the polyimide film is provided at a thickness of from 10 to 80 nm. The resulting substrate is then subjected to uniaxial orientation treatment by a rubbing process, and a hydrophobic or hydrophilic layer is applied. Suitable layer are obtained with polystyrene sulfonate, polyacrylic acid sodium salt, octadecyltrichlorosilane, 3-aminopropyltrimethoxysilane, and 3-aminoethyl-2-aminopropyltrimethoxysilane. Micro-spherical polymer of latex particles functionalized with amine or carboxylate groups, such as Polybead™ microspheres (ex Polyscience Inc., USA), functionalized spheres (hydroxyl, carboxyl, sulfate, sulfonate, amino groups) from Microparticles GmbH, carboxy-modified microparticles from Seradyn; or amino- and carboxy-modified microparticles from Kisker-Biotech can be used.

Thus, as described in the foregoing, the present invention realizes a process for fabricating a liquid crystal electro-optical device simplified in process and shortened in process time.

### THE INVENTION IS FURTHER ILLUSTRATED BY THE FOLLOWING NON-LIMITATIVE EXAMPLES

Materials and Chemicals

The following samples were all coated with an indiumtinoxide (ITO) conductive layer as the first layer.

Samples

substrates used are:

a) glass
b) synthetic resin foil from TEIJIN (code DT 120 B60)
c) synthetic resin foil OIKE-PET (code LR-TS)

The synthetic resin foils were clipped with a cutter using a microscope slide as a pattern.

Microspheres (Polymeric Particles, Spacers)

Polybead™ microspheres (monodisperse polystyrene latex particles) with two different functional groups were used.
Amine-Functionalized
Carboxylate-functionalized.
The spheres were diluted in deionized water and measured in drops.
   Modifiers

To modify the ITO-surface the following polymers:
PSS (polystyrene sulfonate)
PM (polyacrylic acid, sodium salt)
as a hydrophilic second layer which can be provided with an electrostatic charge and the molecules:
OTS (octadecyltrichlorosilane)
A 1100 (3-aminopropyltrimethoxysilane)
A 1120 (3-(2-aminoethylaminopropy)1trimethoxysilane)
were used for making a hydrophobic second layer.
   Microspheres Solutions
   Making the Solution

The microspheres were measured in drops (one drop weights approximately 35 mg) and diluted with deionized water and optionally charged (pH-change) with using a strong acid like HCI (for the aminospheres) or a base like NaOH (for the carboxyspheres). Mostly uncharged solutions were used.

Using the Solution

The microspheres solution for the dipping experiment was stirred using a lab cooker and a magnetic stirrer. For the spin coating technique, a shook solution was dropped with a Pasteur pipette.

Sample Preparation

The sample substrates were cleaned with different cleaning technologies before starting the experiment
Washing with ethanol and drying in air at RT
Washing with ethanol, wiping with a Kimberly-Clark cloth and drying in the oven (333K), and the surface was activated by one of the following procedures
UV-ozone
Plasma-oxygen

Electrostatic bonding of polymer particles to the at least one of the first the second or third layer.

Bonding of Microspheres Without Surface Modification

The samples were placed vertically in a plastic beaker with a solution of microspheres. After the bath several cleaning techniques such as:
dipping in deionized water and/or ethanol,
spraying with deionized water and/or ethanol, and
blowing with pressed air, were performed.

The drying of the samples followed in air at room temperature (22° C.) or in the oven at 60 to 90° C.

Surface Modification (Dipping) and Bonding of Microspheres (Dipping)

Modifiers were used to increase the bonding-ability of the ITO. A normal dipping experiment, followed by a rinsing and/or cleaning step (water-ethanol) and drying in the oven at 60° C. The bonding part was the same as described above.

Surface Modification (Stamping) and Bonding of Microspheres (Dipping)

In the experiment a PDMS stamp was employed. (Reference: Xia, Y. N. and G. M. Whitesides (1998). “Soft lithography.” Annual Review of Materials Science 28: 153-184). The ink (modifier) was applied onto the stamp with a Pasteur pipette and the solution was spread by spin coating. To dry the stamp completely and to avoid a dirty pattern it was blown with pressed air for a few seconds. Then the stamp was turned and pressed with the fingers onto the sample and removed after 5 seconds by using a pair of tweezers. The bonding is described above.

Surface Modification (Stamping) and Bonding of Microspheres (Spin Coating)

The stamping part was the same as above. For the bonding, part of the stamped sample was mounted onto the chuck of the spin coater and the microspheres solution was dropped with a Pasteur pipette. To give the spheres the possibility to bond to the surface, a waiting time (sedimentation time) was introduced. Spin coating at slow speed (1000 rpm) was then used for removing the solution. The sample was completely dried by placing it in the oven at 60° C. for 10-15 minutes.

Results

Surface modifications were obtained by using PSS, PAA, A1000, and A1120 followed by dipping the samples in a solution of microspheres, having a concentration of 0.01 to 5 wt. % and a pH between 5 and 10. By adding NaOH the carboxylated spheres were charged and by adding HCI the ITO layer was charged. Using a glass-ITO substrate and carboxylate-functionalized microspheres in concentration (0.01 to 5 wt. %) a dip time of 5 min was sufficient to show a good coverage.

The non-adhering modifier molecules were removed to prevent a contamination of the microsphere solution during the bonding experiments. Dipping in deionized water for a few seconds for several iterations appears a good treatment. Other techniques like rinsing or dipping in flowing water can also be carried out. Non-bonded microspheres could be removed by dipping, rinsing and spraying, or by blowing with pressed air. After surface modification the samples were dried at 60° C.

1. A method of obtaining a pair of substrates spaced from each other by spacers comprising:
a) providing a first substrate overlaid with a first layer with a patterned hydrophobic second layer or a patterned hydrophilic second layer that can take on an electrostatic charge; and
b) optionally treating the parts of the first layer that are not covered with the hydrophobic or hydrophilic second layer to form a patterned hydrophilic third layer that can take on an electrostatic charge with a sign that is opposite to the sign of the electrostatic charge that can be taken on by the hydrophilic second layer, if the second layer is a hydrophilic layer;
c) providing at least one of the first, second, and third layer with an electrostatic charge;
d) contacting the electrostatically charged patterned first substrate with a dispersion of polymeric particles (spacers), which are functionalized so that the polymeric particles at their surface can take on an electrostatic charge with a sign opposite to the sign of the electrostatic charge of the at least one of the first, second, and third layer, to electrostatically bond the polymeric particles to the layer provided with an electrostatic charge having a sign that is opposite to the sign of the electrostatic charge of the polymeric particles;
e) optionally removing the functionalized polymeric particles from parts to which the functionalized polymeric particles are not electrostatically bonded, and/or the hydrophobic or hydrophilic second layer, if the polymeric particles are not electrostatically bonded thereto; and
f) thereafter connecting the first substrate to a second substrate to give the pair of substrates.

2. The method according to claim 1 wherein the first layer is a conductive or semi-conductive layer.

3. The method according to claim 1 wherein the first layer is an alignment layer.

4. The method according to claim 2 wherein the conductive or semi-conductive layer is overlaid with an alignment layer.

5. The method according to claim 1 wherein spherically shaped functionalized polymeric particles are used.

6. The method according to claim 5 wherein polymeric particles are used having a diameter of about 1 μm to about 10 μm.

7. The method according to claim 1 wherein the polymeric particles are functionalized with acid groups or basic groups.

8. The method according to claim 1 wherein the polymeric particles are functionalized with carboxylic acid or sulfonic acid groups or with amine groups.

9. A device comprising two substrates spaced from each other by polymeric particles (spacers), at least the first substrate being overlaid with a first layer and patterned by a hydrophobic or hydrophilic second layer, and optionally by a hydrophilic third layer that has an electrostatic charge with a sign that is opposite to the sign of the electrostatic charge of the hydrophilic second layer, if the second layer is a hydrophilic layer; and wherein at least one of the first, second, and third layer has an electrostatic charge, characterized in that the polymeric particles are positioned between the pair of substrates in a pre-determined pattern and are functionalized so that the polymeric particles at their surface have an electrostatic charge with a sign that is opposite to the sign of the electrostatic charge of at least one of the first, second, or third layer to which the polymeric particles are electrostatically bonded.

10. A pair of substrates spaced from each other by polymeric particles (spacers) wherein the polymeric particles are positioned between the pair of substrates in a pre-determined pattern and are functionalized so that the polymeric particles at their surface have groups that can take on an electrostatic charge.

11. An LCD display comprising the pair of substrates of claim 10 wherein at least one of the substrates may optionally be provided with at least one layer selected from an electrode layer and an alignment layer.
